(19) United States
(12) Patent Application Publication
(10) Pub. No.: US 2026/0221475 A1
(43) Pub. Date: Jul. 30, 2026

(54) MEMBRANE BLOCK

(71) Applicant: MAHLE International GmbH, Stuttgart (DE)

(72) Inventor: Sven Alexander Kaiser, Waiblingen (DE)

(21) Appl. No.: 19/148,306

(22) PCT Filed: Dec. 21, 2023
(86) PCT No.: PCT/EP2023/087316

§ 371 Date: Jul. 15, 2025

(30) Foreign Application Priority Data
Jan. 16, 2023 (DE) 10 2023 200 305.8

(51) Int. Cl. H01M 8/04119

(52) U.S. Cl. CPC H01M 8/04149

(57) ABSTRACT

A membrane block for a humidifier may include a plurality of membrane elements stacked one above another in a height direction. Each membrane element may include a flat membrane and a rectangular frame enclosing the flat membrane. The membrane block may further include a plurality of first flow channels and a plurality of second flow channels formed in an alternating fashion in the height direction. The first flow channels may be closed in the longitudinal direction and may conduct a through flow in the width direction. The second flow channels may be closed in the width direction and may conduct a through flow in the longitudinal direction. Each pair of adjacent membrane elements may be displaced relative to one another in the width direction and/or in the longitudinal direction such that a respective flow channel is defined between the respective pair of adjacent membrane elements.

### CROSS-REFERENCE TO RELATED APPLICATIONS

This application claims priority to International Patent Application No. PCT/EP2023/087316, filed on Dec. 21, 2023, and German Patent Application No. DE 10 2023 200 305.8, filed on Jan. 16, 2023, the contents of both of which are hereby incorporated by reference in their entirety.

### TECHNICAL FIELD

The invention relates to a membrane block for a humidifier. The invention also relates to a humidifier having a housing and the membrane block arranged in the housing.

### BACKGROUND

A humidifier is, for example, used in a fuel cell system with a fuel cell to humidify dry supply air flowing toward the fuel cell using humid exhaust air flowing away from the fuel cell. In this case, the humidifier usually comprises a membrane block with several membrane elements stacked together. The respective membrane element can comprise a flat flexible membrane that is encased and stabilized by a circumferential frame. The membrane elements are stacked on top of each other in a height direction, wherein the frames of the membrane elements are arranged at a distance from each other. As a result, a plurality of flow channels are formed between the membrane elements or between the membranes of the membrane elements, which flow channels can be flowed through in the height direction of the membrane block in alternating fashion by the exhaust air and by the supply air. Due to the frames themselves and the required distance between the frames, the membrane block disadvantageously has an increased installation space requirement in the height direction. If the height of the membrane block is reduced in the height direction, the number of membrane elements and thus the membrane are also reduced. This results in a reduced water transfer rate in the membrane block.

DE 10 2020 212 596 A1 discloses a humidifier with such a membrane block.

### SUMMARY

The object of the invention is therefore to provide an improved or at least alternative embodiment for a membrane humidifier of the generic type and for a humidifier of the generic type that overcome the described disadvantages.

According to the invention, this problem is solved by the scope of the independent claim(s). Advantageous embodiments are the scope of the dependent claim(s).

The present invention is based on the general idea of stacking the membrane elements of the membrane block without a distance between the frames, thus reducing the height of the membrane block in height direction, and to move them in relation to each other transversely in the height direction, thus opening the flow channels laterally and allowing them to be flowed through.

The inventive humidifier is intended or designed for a humidifier, in particular of a fuel cell system with a fuel cell. The membrane block comprises a plurality of membrane elements stacked on top of each other in a height direction. The respective membrane element comprises a flat membrane and a rectangular frame that encloses the membrane along the perimeter. The respective membrane element extends in a longitudinal direction and in a width direction and is thus oriented transverse to the height direction. The height direction, the width direction and the longitudinal direction are in relation to the membrane block and in relation to each other each oriented perpendicular. First flow channels and second flow channels are formed in the height direction in alternating fashion between the adjacent membrane elements. The first flow channels can be flowed through in the width direction and are closed in the longitudinal direction and the second flow channels can be flowed through in the longitudinal direction and are closed in the width direction. According to the invention, the respectively adjacent membrane elements in the membrane block are displaced in relation to each other in the width direction or in the longitudinal direction. As a result, frame regions of the frames of the respectively adjacent membrane elements oriented in the width direction abut one another and frame regions of the frames of the respectively adjacent membrane elements oriented in the longitudinal direction with one another do not abut one another, or frame regions of the frames of the respectively adjacent membrane elements oriented with one another or longitudinal direction abut one another and frame regions of the frames of the respectively adjacent membrane elements oriented in the width direction do not abut one another. As a result, the first flow channel or the second flow channel is formed between the respectively adjacent membrane elements.

The respective membrane elements are arranged against one other in the height direction without a distance between the frames, thus minimizing the height of the membrane block defined in the height direction. The respectively adjacent membrane elements are in this case displaced in relation to one another in the width direction or in the longitudinal direction, thus opening the flow channels toward the outside between the membrane elements. The frame of the respective membrane element comprises two frame regions opposite each other and oriented in the width direction and two frame regions opposite each other and oriented in the longitudinal direction. The frame regions are merged at corners of the frame. If the respectively adjacent membrane elements are displaced relative to each other in the width direction, the frame regions of the frames oriented in the width direction are positioned on top of each other and the frame regions of the frames oriented in the longitudinal direction do not abut each other. As a result, the flow channel between the respectively adjacent membrane elements can be flowed through in width direction and cannot be flowed through, or is closed, in the longitudinal direction. The first flow channel is thus formed. If the respectively adjacent membrane elements are displaced relative to each other in the longitudinal direction, the frame regions of the frames oriented in the longitudinal direction are positioned on top of each other and the frame regions of the frames oriented in the width direction do not abut each other. As a result, the flow channel between the respectively adjacent membrane elements can be flowed through in longitudinal direction and cannot be flowed through, or is closed, in the width direction. The second flow channel is thus formed. The respective membrane elements can be connected, preferably glued, to the frame in a substance-to-substance bond.

The frame regions of the frames of the respectively adjacent membrane elements oriented in the longitudinal direction or in the width direction are displaced relative to one another. In this case, the respective frame regions can be displaced relative to one another such that the respectively first flow channel or the respectively second flow channel can be flowed through and/or such that the respectively first flow channel or the respectively second flow channel is open toward the outside. The frame regions of the frames of the respectively adjacent membrane elements oriented in the longitudinal direction or in the width direction, and which do not abut one another, can have a distance to one another. As a result, a flowable section can be formed between these frame regions of the frame. The respectively first flow channel or the respectively second flow channel can then be formed at least in regions, i.e. completely or only partially, by the respectively flowable section.

The respective frame can in particular have a constant height in the height direction. In other words, the respective frame can circumferentially have a constant height in height direction. Due to the constant height of the respective frame, the adjacent frames are directly on top of each other in contact regions. The respective contact regions are in this case for the first flow channels formed by the adjacent frame regions of the adjacent frames abutting in the width direction and for the second flow channels by the adjacent frame regions of the adjacent frames abutting in the longitudinal direction. Due to the constant height of the respective frames, a seal can be formed in the respective contact regions, so that no additional sealing materials must be introduced between the individual frames or the individual membrane elements. The constant height of the respective frames thus prevents gaps between the frames of the respective membrane elements in the respective contact regions, thus preventing air from flowing into the membrane block via the respective contact regions.

The respective membranes and the respective frames are rectangular. The respective membrane can be overmolded with plastic, thus forming the rectangular frame that encloses the membrane. The membrane and the frame can therefore be connected to one another in a substance-to-substance bond or in an inseparable fashion. The respective membrane can be flat and flexible and can be supported and stabilized or stiffened by the frame. A height of the frame defined in the height direction can in particular be greater than a thickness of the membrane defined in the height direction. As a result, the first or the second flow channel can be formed between the membranes of the respectively adjacent membrane elements. In other words, the membranes of the respectively adjacent membrane elements can for stacked frames be arranged spaced apart from one another. The respective frame can have a c-shaped cross-section transverse to the width direction and/or the longitudinal direction and can enclose the membrane along the perimeter. The width of the respective frame defined in the width direction/longitudinal direction can be identical on all sides. The membrane elements can expediently be displaced in the width direction and/or in the longitudinal direction more than by the width of the frame defined in the width direction and/or in the longitudinal direction.

In a conceivable embodiment of the membrane block, four membrane elements stacked on top of each other in the stack direction can each form a membrane group, and the membrane groups can be arranged on top of each other in the height direction. The second membrane element of the respective membrane group can be displaced in the positive width direction by a first distance with respect to the first membrane element of the respective membrane group. The third membrane element of the respective membrane group can be displaced in the positive longitudinal direction by a second distance with respect to the second membrane element of the respective membrane group. The fourth membrane element of the respective membrane group can be displaced in the negative width direction by a third distance with respect to the third membrane element of the respective membrane group. The first membrane element of the subsequent membrane group can be displaced in the negative longitudinal direction by a fourth distance with respect to the fourth membrane element of the preceding membrane group.

It goes without saying that the respective membrane elements of the respective membrane group follow their numbers in height direction. The fourth membrane element of the one membrane group is followed in the height direction by the first membrane element of the other membrane group. The displacement takes place in the width direction or in the longitudinal direction, in each case positively or negatively. A positive and a negative displacement occur inversely.

The first distance and the third distance can be identical to each other. As a result, the displacement of the membrane elements in the positive width direction can be compensated by the displacement of the membrane elements in the negative width direction. The second distance and the fourth distance can be identical to each other. As a result, the displacement of the membrane elements in the positive longitudinal direction can be compensated by the displacement of the membrane elements in the negative longitudinal direction. As a result, the respective membrane elements with the same number lie one above the other in the height direction or are not displaced in the width direction and/or in the longitudinal direction. However, the membrane elements with the same number are arranged in groups displaced in relation to each other according to their numbers. If the first distance and the third distance as well as the second and fourth distances are identical, four edge regions of the membrane block are oriented in height direction and the membrane block is cuboid. It is also conceivable that all distances in the membrane block are identical to each other. In other words, the displacement in positive and negative longitudinal directions and in positive and negative width directions can be equal in size. The respective distance can in particular be greater than the width of the respective frame of the membrane element; as a result, a channel or an opening leading to the outside is formed between the frames of the adjacent membrane elements. In other words, the respective flow channel can as a result be opened to the outside.

In the embodiment described above, the first flow channel, which can be flowed through in the width direction and is closed in the longitudinal direction, can be formed in the membrane block between the first and second membrane elements respectively and between the third and fourth membrane elements respectively. The second flow channel, which can flowed through in the longitudinal direction and is closed in the width direction, can then be formed in the membrane block between the second and third membrane elements respectively and the fourth and first membrane elements respectively. As already described above, when displaced in the width direction, the frame regions of the respective frames oriented in width direction are stacked on top of each other and the frame regions of the frames oriented in longitudinal direction are not stacked on top of each other. This forms the first flow channel that can be flowed through in the width direction and is closed in the longitudinal direction. By contrast, when displaced in longitudinal direction, the frame regions of the respective frames oriented in longitudinal direction are stacked on top of each other and the frame regions of the frames are not oriented in width direction are not stacked on top of each other. This forms the second flow channel that can be flowed through in the longitudinal direction and is closed in the width direction.

A geometric surface of the membrane element defined transversely to the height direction can be smaller than a geometric surface of the membrane block defined transversely to the height direction. In other words, the displaced stacking of the membrane elements, the membrane block can transversely to the height direction assume a larger area than each of the respective membrane elements.

The respective membrane elements can be identically shaped in relation to each other. This makes the fabrication of the membrane block much easier.

The respective membrane element can comprise at least one corner element that extends the frame, and the respective corner element can at a corner of the frame extend outward from the frame transverse to the height direction. The respective corner elements and/or the respective frames of the respective membrane elements can be stacked on top of each other in the height direction and form a continuous edge region of the membrane block in the height direction. For this purpose, the respective corner elements can have a height defined in the height direction, which corresponds to a height of the frame defined in the height direction. Without the respective corner elements, the frames of the respective membrane elements are arranged displaced in relation to one another at the edges of the membrane block oriented in the height direction. As a result, the respective edge regions of the membrane block are not continuous or have gaps in height direction. The corner elements can close these gaps such that the edge regions of the membrane block are continuous. This makes it easier to seal the membrane block at the respective edges oriented in height direction.

In particular, exactly three corner elements can be provided on the respective membrane element and can be formed on exactly three corners of the respective frame. The respective corner element can project in the width direction and/or in the longitudinal direction, respectively such that the displacement of the frame or the membrane element is compensated in width direction and/or in longitudinal direction. The respective corner elements can be formed differently from one another. Thus, the one corner element can project outward from the frame only in the width direction, the other corner element only in the longitudinal direction, and the further corner element in width direction and in longitudinal direction. All membrane elements or all frames with the corner elements can be formed identically to one another.

The respective frame of the respective membrane element can comprise at least one stiffening rib. The respective stiffening rib can connect two opposing frame regions of the frame to one another and thus stiffen the respective membrane of the membrane element. The respective stiffening rib can be integrally formed with the frame itself or be an inseparable part of the frame. The stiffening rib can be bonded to the membrane in a substance-to-substance bond. The respective stiffening rib facing the first flow channel can be oriented in width direction and/or the respective stiffening rib facing the second flow channel can be oriented in longitudinal direction. In other words, the respective stiffening rib can be oriented in a flow direction of the fluid in the respective flow channel formed between the adjacent membrane elements. The frame can also comprise at least one stiffening rib on both sides of the membrane. The stiffening ribs of the adjacent membrane elements can abut one another and thus define the distance of the respective membranes to one another.

The invention also relates to a humidifier having a housing and a membrane block arranged in the housing. The membrane block is formed according to the invention as described above. In order to avoid repetitions, reference is made here to the above description.

Further important features and advantages of the invention are apparent from the dependent claims, from the drawings, and from the associated description of the figures with reference to the drawings.

It is understood that the above-mentioned features and those yet to be explained below can be used not only in the combination indicated in each case, but also in other combinations or on their own, without deviating from the scope of the present invention.

Preferred exemplary embodiments of the invention are shown in the drawings by way of example and will be explained in more detail in the following description, wherein identical reference signs refer to identical or similar or functionally identical elements.

### BRIEF DESCRIPTION OF THE DRAWINGS

### The Drawings Show, Schematically in Each Case, in:

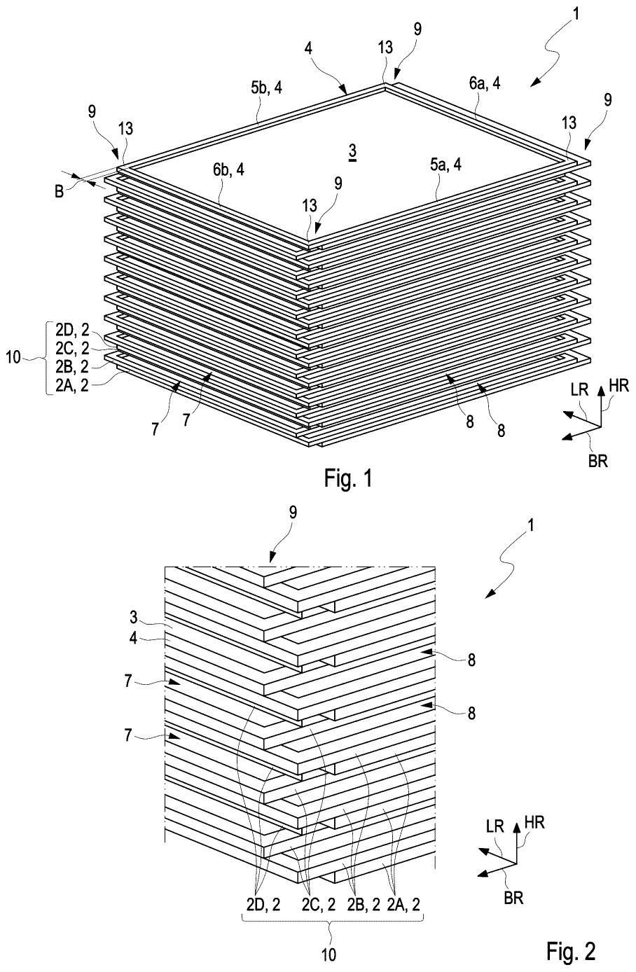

FIG. 1 shows a view of an inventive membrane block in a first embodiment;

FIG. 2 shows a view of an edge region oriented in height direction of the inventive membrane block in the first embodiment;

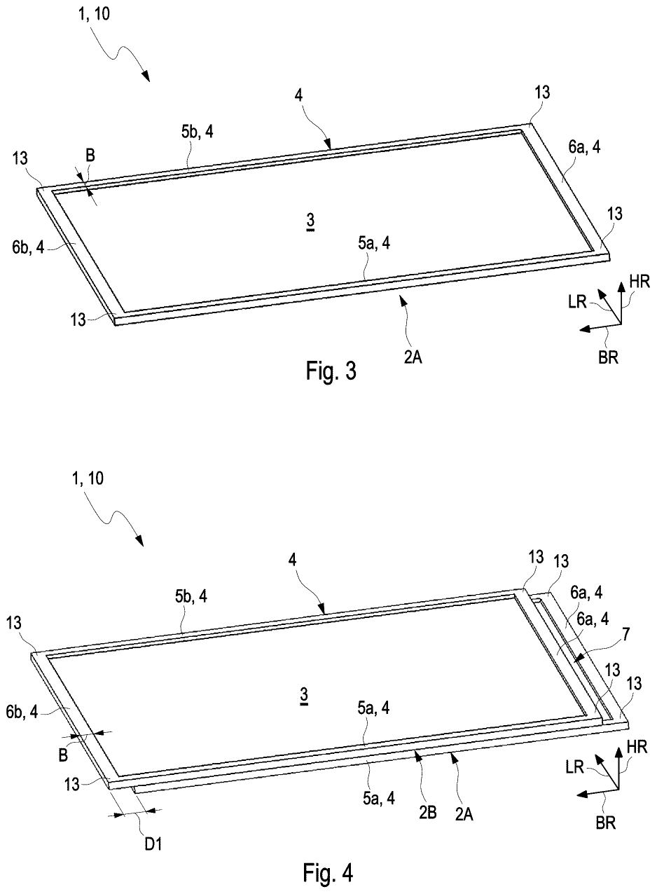

FIGS. 3 through 7 show views of a step-by-step stacking of membrane elements in the inventive membrane block in the first embodiment;

FIG. 8 shows a sectional view of the inventive membrane block in the first embodiment;

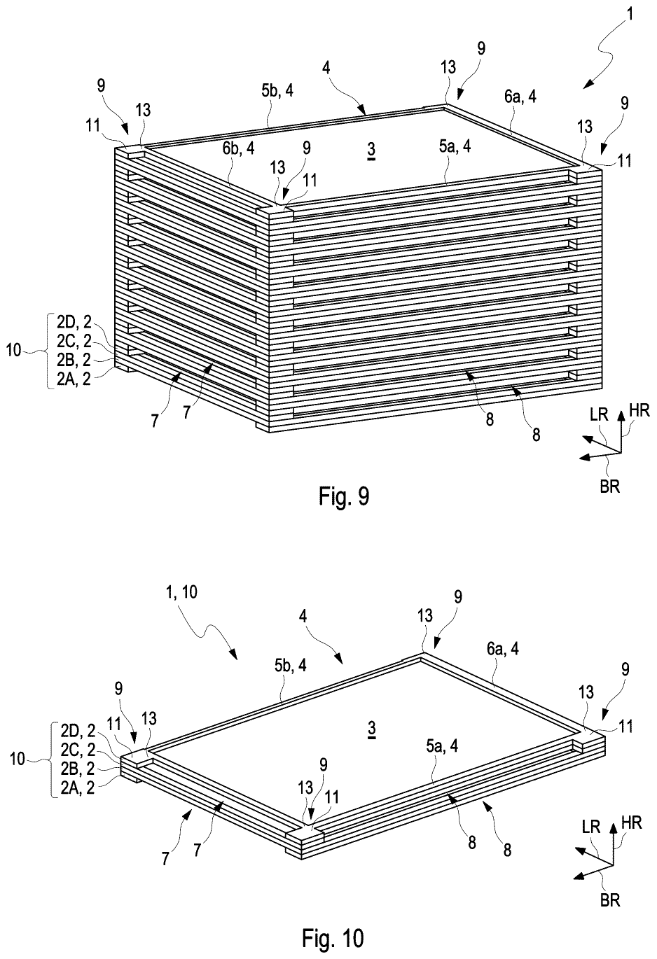

FIG. 9 shows a view of the inventive membrane block in a second embodiment;

FIG. 10 shows a view of a membrane group of the inventive membrane block in the second embodiment;

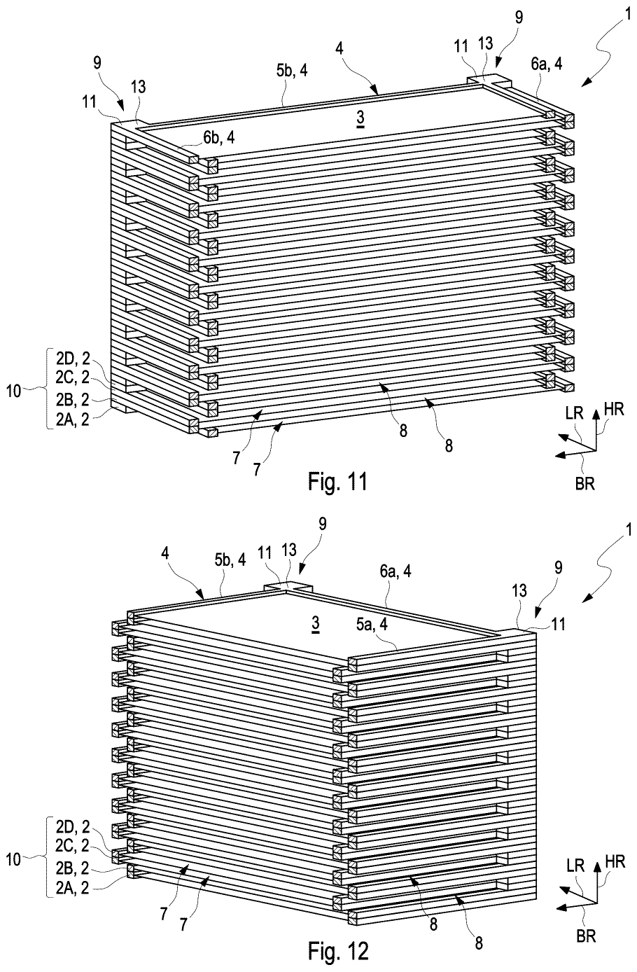

FIGS. 11 and 12 show sectional views of the inventive membrane block in the second embodiment, each transverse to the longitudinal direction and transverse to the width direction;

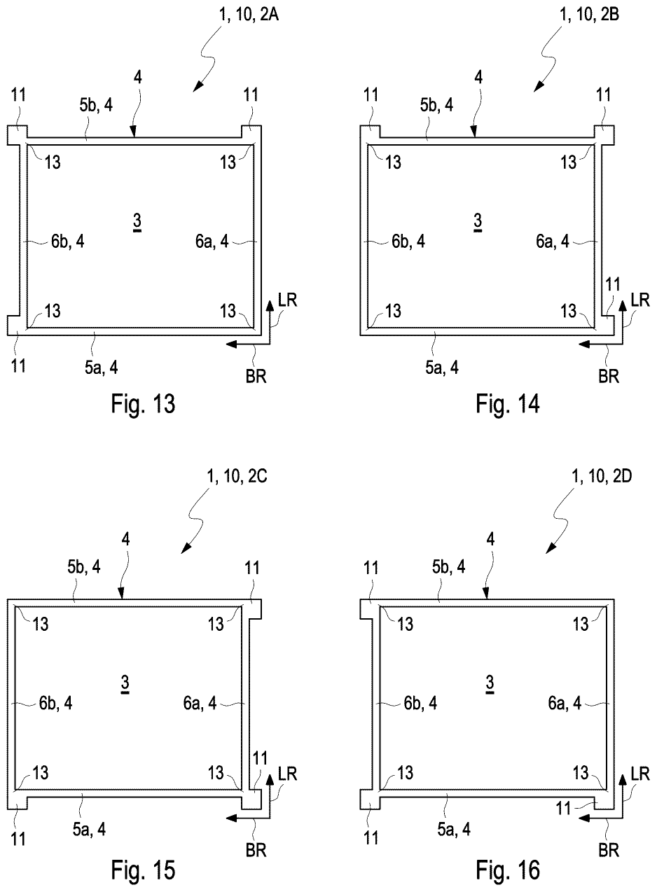

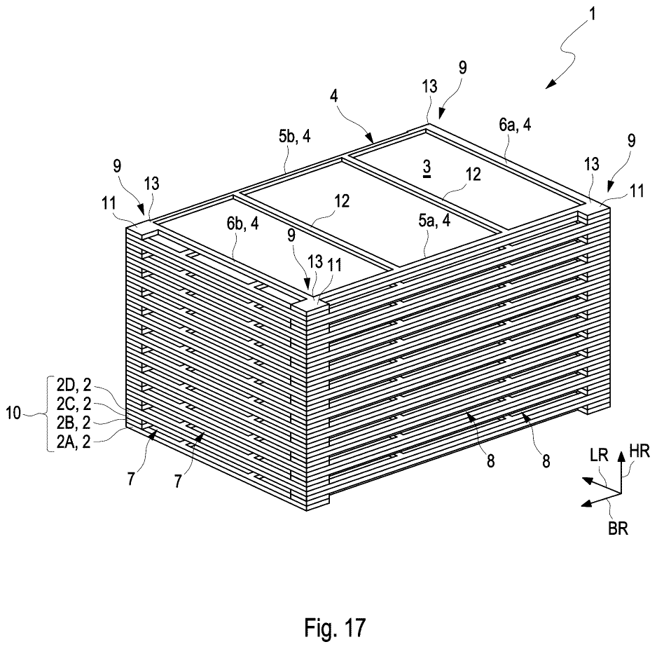

FIGS. 13 through 16 show views of membrane elements of the respective membrane group of the inventive membrane block in the second embodiment;

FIG. 17 shows a view of the inventive membrane block in a third embodiment;

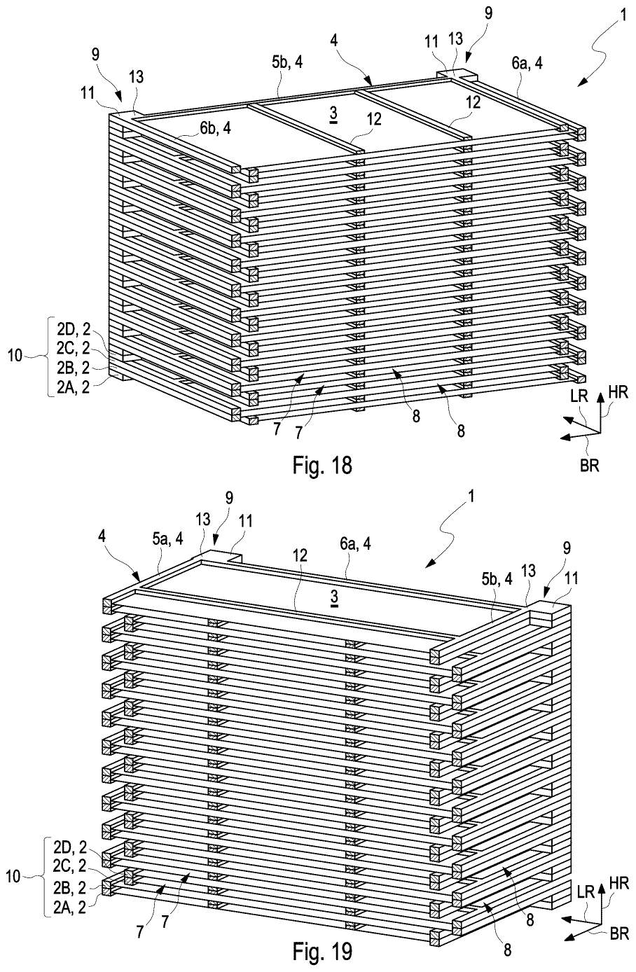

FIGS. 18 and 19 show sectional views of the inventive membrane block in the third embodiment, respectively transverse to the longitudinal direction and transverse to the width direction;

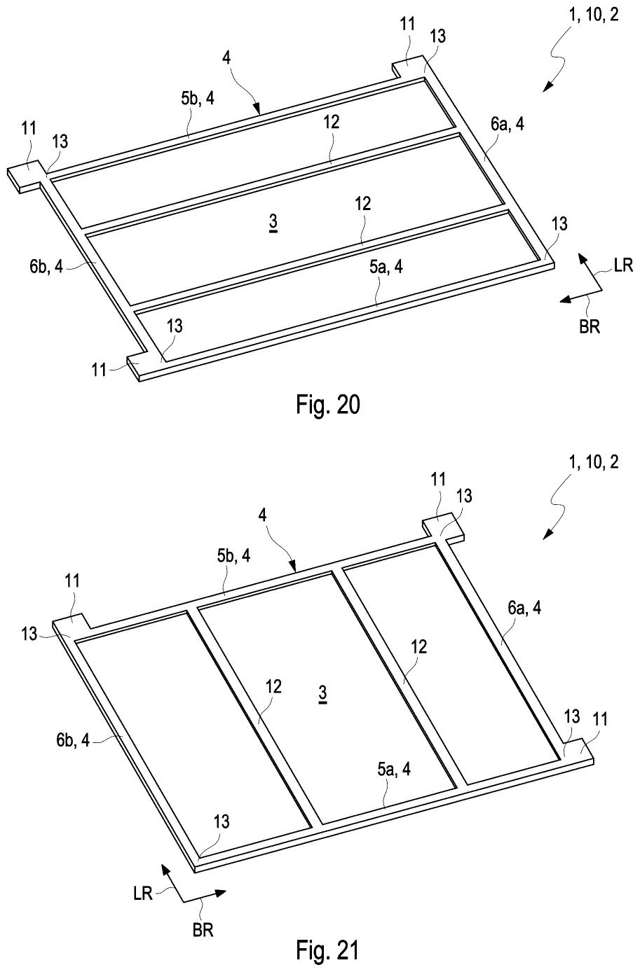

FIGS. 20 and 21 show views of a membrane element of the inventive membrane block in the third embodiment from deviating sides.

### DETAILED DESCRIPTION

FIG. 1 shows a view of an inventive membrane block 1 in a first embodiment. The membrane block 1 comprises a plurality of membrane elements 2, which are in a height direction HR of the membrane block 1 stacked on top of each other and are positioned regionally one above the other. The respective membrane element 2 extends transversely to the height direction HR and/or in a width direction BR and in a longitudinal direction LR. The height direction HR, the width direction BR and the longitudinal direction LR are oriented perpendicular to each other. The respective membrane element 2 comprises a rectangular membrane 3 and a rectangular frame 4 enclosing the membrane 3. The frame 4 comprises two opposing frame regions 5a and 5b and two opposing frame regions 6a and 6b. The frame regions 5a and 5b are oriented in the width direction BR and the frame regions 6a and 6b are oriented in the longitudinal direction LR. The respectively opposing frame regions 5a and 5b and 6a and 6b are oriented at a distance from one another and are merged at corners 13 of the frame 4. The frame 4 has a width B transverse to the height direction HR. The frame 4 also has a circumferentially constant height in the direction of height HR. Hereinafter, individual elements are shown on one of the membrane elements 2 for clarity.

The frame 4 has a c-shaped cross-section transverse to the width direction BR and transverse to the longitudinal direction LR. A height of the frame 4 defined in the height direction HR is greater than a thickness of the membrane 3 defined in the height direction HR such that first and second flow channels 7 and 8 are formed between the membranes 3 of the membrane elements 2 adjacent in the height direction HR. The first flow channels 7 can be flowed through in the width direction BR and are closed in the longitudinal direction LR and extend parallel to and between the frame regions 5a and 5b of the frame 4 of the adjacent membrane elements 2. The second flow channels 8 are flowable in the longitudinal direction LR and are closed in the width direction BR and extend parallel to and between the frame regions 6a and 6b of the frame 4 of the adjacent membrane elements 2. The first flow channels 7 and the second flow channels 8 are arranged in an alternating fashion in the height direction HR.

The frames 4 of the respective membrane elements 2 are circumferential and enclose the membranes 3 on all sides. So that the flow channels 7 and 8 can continue to be flowed through, the respectively adjacent membrane elements 2 are displaced relative to each other in the width direction BR or in the longitudinal direction LR. As a result, the frames 4 of the respective membrane elements 2 exclusively abut one another at the frame regions 5a and 5b oriented in the width direction BR or at the frame regions 6a and 6b oriented in the longitudinal direction LR and do not abut one another at the other frame regions 6a and 6b or at the other frame regions 5a and 5b. The stacking of the respective membrane elements 2 on each other is explained in more detail below with reference to FIG. 3 through FIG. 7.

The membrane block 1 is designed for a humidifier of a fuel cell system having a fuel cell. The first flow channels 7 can be flowed through with a dry supply air flowing to the fuel cell and the second flow channels 8 can be flowed through with a wet exhaust air flowing from the fuel cell or vice versa. The membrane 3 of the respective membrane elements 2 are air impermeable and water vapor permeable such that the dry supply air can be moistened within the membrane block 1 using the moist exhaust air.

FIG. 2 shows a view of one of the four edge regions 9 of the inventive membrane block 1 in the first embodiment oriented in height direction HR. The respective edge region 9 is formed along an edge of the membrane block oriented in height direction HR. Since the individual membrane elements 2 are displaced in relation to one another, the respective edge region 9 of the membrane block 1 is not continuous and has gaps.

FIG. 3 through FIG. 7 show views of a stepwise stacking of the membrane elements 2 in the inventive membrane block 1 in the first embodiment. Here, four membrane elements 2 each form a membrane group 10 stacked on top of each other in the height direction HR. The individual membrane groups 10 are arranged one above the other in the height direction of the membrane block 1. The membrane block 1 can have any number of membrane groups 10. It is also conceivable that the membrane group 10 first in height direction HR and/or last in height direction HR are incomplete.

In order to simplify the following description, the membrane elements 2 of the respective membrane group 10 are assigned numbers. The respective membrane group 10 thus comprises a first membrane element 2A, a second membrane element 2B, a third membrane element 2C and a fourth membrane element 2D. The membrane elements 2A, 2B, 2C, 2D are identical to each other and the distinction is strictly made to simplify the description. In the respective membrane group 10, the membrane elements 2A, 2B, 2C, 2D follow each other according to their numbers in the height direction HR. If another membrane group 10 adjoins in the height direction HR, the first membrane element 2A of the subsequent membrane group 10 follows the fourth membrane element 2D of the preceding membrane group 10. In the height direction HR, the membrane elements are therefore arranged in the following order . . . 2D, 2A, 2B, 2C, 2D, 2A . . . .

Referring to FIG. 3, the first membrane element 2A is arranged in an initial position.

Referring to FIG. 4, the second membrane element 2B is displaced in the positive width direction BR by a distance D1 with respect to the first membrane element 2A. The distance D1 is greater than the width B of the frame 4. The frame regions 5a and 5b of the frame 4 of the membrane elements 2A and 2B oriented in the width direction BR are stacked on top of one another and the frame regions 6a and 6b of the frame 4 of the membrane elements 2A and 2B oriented in the longitudinal direction LR are displaced in relation to one another. The first flow channel 7 is thus formed between the membrane elements 2A and 2B. The first flow channel 7 is closed in the longitudinal direction LR and/or transverse to the width direction BR by the adjacent frame regions 5a and 5b of the frame 4 and is opened in the width direction BR and/or transverse to the longitudinal direction LR by the frame regions 6a and 6b of the frame 4 displaced in relation to one another. The first flow channel 7 can accordingly be flowed through in the width direction BR and is closed in the longitudinal direction LR.

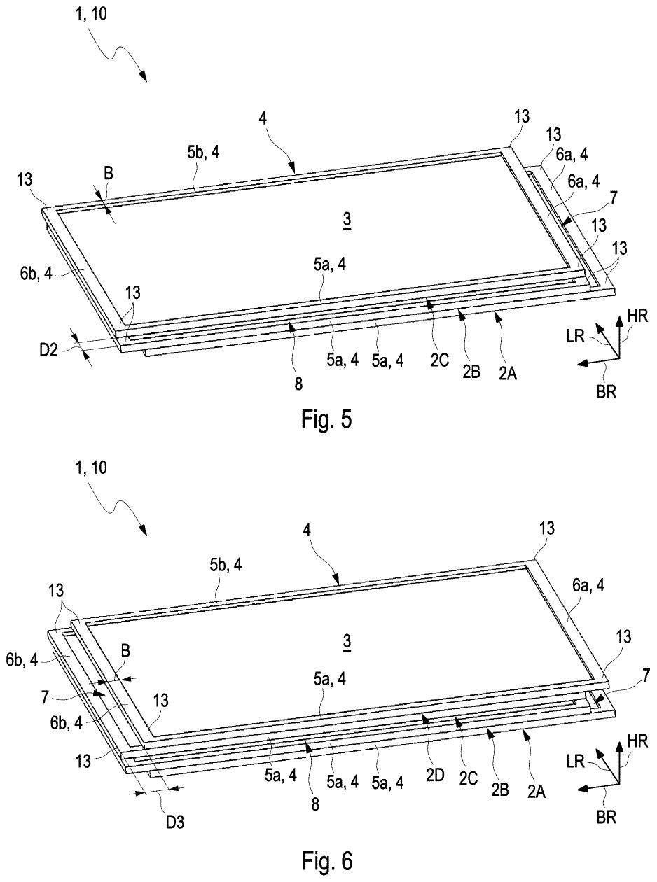

Referring to FIG. 5, the third membrane element 2C is displaced with respect to the second membrane element 2B in the positive longitudinal direction LR by a distance D2. The distance D2 is greater than the width B of the frame 4. The frame regions 6a and 6b of the frame 4 of the membrane elements 2B and 2C oriented in the longitudinal direction LR are stacked on top of one another and the frame regions 5a and 5b of the frame 4 of the membrane elements 2B and 2C oriented in the width direction BR are displaced in relation to one another. The second flow channel 8 is thus formed between the membrane elements 2B and 2C. The second flow channel 8 is closed in the width direction BR and/or transverse to the longitudinal direction LR by the adjacent frame regions 6a and 6b of the frame 4 and is opened in the longitudinal direction LR and/or transverse to the width direction BR by the frame regions 5a and 5b of the frame 4 displaced in relation to one another. The second flow channel 7 can accordingly be flowed through in the longitudinal direction LR and is closed in the width direction BR.

Referring to FIG. 6, with respect to the third membrane element 2B, the fourth membrane element 2D is displaced in the negative width direction BR by a distance D3. The distance D3 is greater than the width B of the frame 4. The negative width direction BR is oriented opposite to the positive width direction BR. The distance D3 corresponds to the distance D1 such that the displacement of the second membrane element 2B is compensated by the displacement of the fourth membrane element 2D. Analogous to the displacement in the positive width direction BR according to FIG. 4, the first flow channel 7 is formed between the membrane elements 2C and 2D.

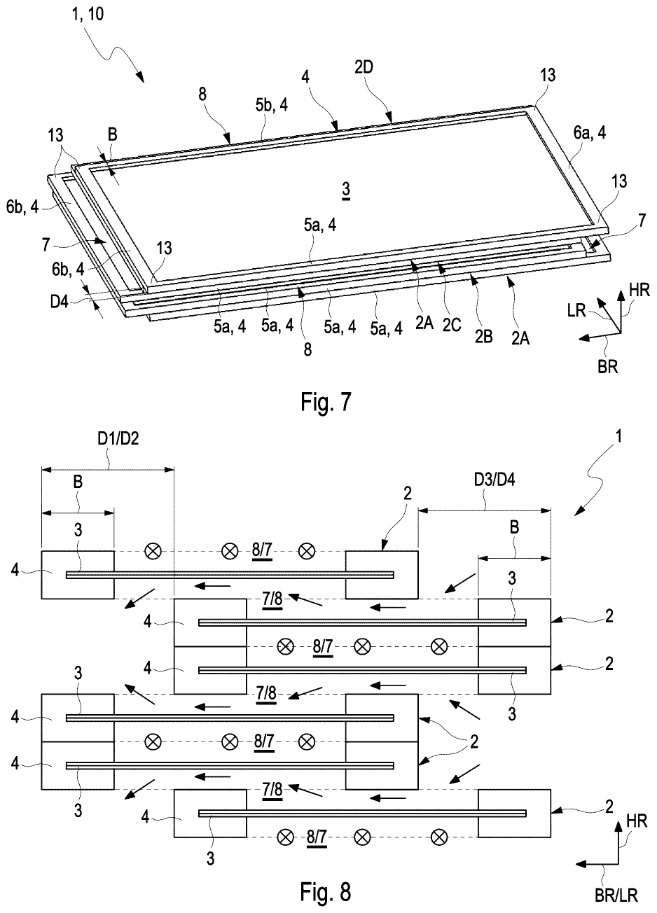

Referring to FIG. 7, the first membrane element 2A of the subsequent membrane group 10 is displaced in the negative longitudinal direction LR by a distance D4 with respect to the fourth membrane element 2D of the preceding membrane group 10. The distance D4 is greater than the width B of the frame 4. The negative longitudinal direction LR is oriented opposite to the positive longitudinal direction LR. The distance D4 corresponds to the distance D2 such that the displacement of the third membrane element 2C is compensated by the displacement of the first membrane element 2A. Analogous to the displacement in the positive longitudinal direction LR according to FIG. 5, the second flow channel 8 is formed between the membrane elements 2D and 2A of the adjacent membrane groups 10.

The second membrane element 2B follows the first membrane element 2A—as already described in FIG. 4. The stacking of the membrane elements 2A, 2B, 2C, 2D can thus continue to occur as desired until the desired height of the membrane block 1 in the height direction HR is reached.

FIG. 8 shows a sectional view of the inventive membrane block 1 in the first embodiment transverse to the width direction/height direction BR/HR. As can be seen in particular here, the distance D1/D3 or D2/D4 is greater than the width B of the frame 4 in the width direction BR such that the flow channels 7/8 are open to the outside. FIG. 8 also shows that the flow channels 7/8 are not linear but are instead S-shaped.

FIG. 9 shows view of the inventive membrane block 1 in a second embodiment. The membrane block 1 in the second embodiment differs only by the shape of the membrane elements 2, as explained in more detail below. The two embodiments are otherwise the same. The membrane elements 2 comprise corner elements 11 that fill the gaps formed by displacing the frames 4 towards each other in the respective edge region 9 of the membrane block 1. As a result, the respective edge region 9 of the membrane block 1 is formed continuously and the membrane block 1 can be readily sealed at its edges.

FIG. 10 shows view of a membrane group 10 of the inventive membrane block 1 in the second embodiment. As can be seen in particular here, the membrane elements 2A, 2B, 2C, 2D are displaced relative to one another as well as in the membrane block 1 of the first embodiment. However, in the respective edge region 9 of the membrane block 1, the membrane elements 2A, 2B, 2C, 2D are positioned one above the other in the height direction HR, either with the corner elements 11 or with the frame 4, and form the respectively continuous or gap-free edge region 9 of the membrane block 1.

FIG. 11 and FIG. 12 show sectional views of the inventive membrane block 1 in the second embodiment. In FIG. 11, the membrane block 1 is transverse to the longitudinal direction LR and the membrane block 1 is transverse to the width direction BR in FIG. 12. As can be seen in FIG. 11 and FIG. 12, the respective frame regions 5a and 5b as well as the respective frame regions 6a and 6b of the frame 4 of the adjacent membrane elements 2 are displaced in an alternating fashion in relation to one another. As a result, alternating first and second flow channels 7 and 8 are formed analogously to the first embodiment in the height direction HR.

FIG. 13 through FIG. 16 show views of the membrane elements 2A, 2B, 2C, 2D of the respective membrane group 10 of the inventive membrane block 1 in the second embodiment. The membrane elements 2A, 2B, 2C, 2D shown here are stacked together according to the description in FIG. 3 through FIG. 7. The edge regions 9 of the membrane block 1 can be shaped without any gaps by the corner elements 11, which project outward from the frame 4 in the width direction BR and/or in the longitudinal direction LR. The respective membrane elements 2A, 2B, 2C, 2D are formed identically in relation to each other. The corresponding position for stacking the membrane element 2A, 2B, 2C, 2D can be achieved by rotating/displacing/swiveling the respective membrane element 2.

FIG. 17 shows view of the inventive membrane block 1 in a third embodiment. The membrane block 1 in the third embodiment differs from the second embodiment of the membrane block 1 only by the embodiment of the frames 4 of the membrane elements 2, as explained in more detail below. The two embodiments are otherwise the same. The frames 4 of the membrane elements 2 here have two stiffening ribs 12 on each side of the membrane 3, which connect the frame regions 5a and 5b on one side of the membrane 3 and the frame regions 6a and 6b of the frame 4 on the other side of the membrane 3 and stiffen the frame 4 and the membrane 3, respectively. The respective stiffening rib 12 is always oriented in the flow direction of the respective flow channel 7 or 8.

FIG. 18 and FIG. 19 show sectional views of the inventive membrane block 1 in the third embodiment. In FIG. 18, the membrane block 1 is transverse to the longitudinal direction LR and the membrane block 1 is transverse to the width direction BR in FIG. 19. As can be seen here, the stiffening ribs 12 of the adjacent frames 4 abut each other and divide the respective flow channel 7 or 8 into partial channels. This improves the flow through the respective flow channel 7 or 8. The stiffening ribs 12 are in the first flow channels 7 oriented in the width direction BR and in the longitudinal direction LR in the second flow channels 8.

FIG. 20 and FIG. 21 show views of the membrane element 2 of the inventive membrane block 1 in the third embodiment. FIG. 20 and FIG. 21 show the membrane element 2 from different sides. The frame 4 comprises two stiffening ribs 12 each on both frame regions of the membrane 2. On one side, the stiffening ribs 12 are provided for the first flow space 7 and are oriented in the width direction BR. On the other side, the stiffening ribs 12 are provided for the second flow channel 8 and are oriented in the longitudinal direction LR.

1. A membrane block for a humidifier, comprising:
a plurality of membrane elements stacked one above another in a height direction;
each membrane element of the plurality of membrane elements including a flat membrane and a rectangular frame enclosing the flat membrane along a perimeter of the flat membrane;
each of the plurality of membrane elements extending in a longitudinal direction and in a width direction;
a plurality of first flow channels and a plurality of second flow channels are formed in an alternating fashion between a respective pair of adjacent membrane elements of the plurality of membrane elements in the height direction;
the plurality of first flow channels flowable through in the width direction and closed in the longitudinal direction;
the plurality of second flow channels flowable through in the longitudinal direction and closed in the width direction;
wherein each pair of adjacent membrane elements are displaced relative to one another in the width direction and/or in the longitudinal direction such that i) a plurality of first frame regions of the frame of a first membrane element of the respective pair of adjacent membrane elements abut a plurality of first frame regions of the frame of a second membrane element of the respective pair of adjacent membrane elements and ii) a plurality of second frame regions of the frame of the first membrane element do not abut a plurality of second frame regions of the frame of the second membrane element a respective flow channel of the plurality of first flow channels and/or the plurality of second flow channels between the respective pair of adjacent membrane elements; and
wherein the plurality of first frame regions of the first membrane element and the second membrane element are oriented in the longitudinal direction or the width direction and the plurality of second frame regions of the first membrane element and the second membrane element are oriented in the other one of the longitudinal direction and the width direction.

2. The membrane block according to claim 1, further comprising a plurality of membrane groups, wherein:
each of the plurality of membrane groups is defined by four membrane elements of the plurality of membrane elements that are stacked on top of each other in the stack height direction;
the plurality of membrane groups are arranged on top of each other in the height direction;
the four membrane elements of each respective membrane group of the plurality of membrane groups includes a first membrane element, a second membrane element, a third membrane element, and a fourth membrane element;
the second membrane element of the respective membrane group is displaced with respect to the first membrane element of the respective membrane group in a positive width direction by a first distance;
the third membrane element of the respective membrane group is displaced in a positive longitudinal direction with respect to the second membrane element of the respective membrane group by a second distance;
the fourth membrane element of the respective membrane group is displaced in a negative width direction with respect to the third membrane element of the respective membrane group by a third distance; and
the first membrane element of a subsequent membrane group is displaced in a negative longitudinal direction with respect to the fourth membrane element of a preceding membrane group by a fourth distance.

3. The membrane block according to claim 2, wherein the first distance and the third distance are identical to one another and/or the second distance and the fourth distance are identical to one another.

4. The membrane block according to claim 2, wherein:
each first flow channel of the plurality of first flow channels between the first membrane elements and the second membrane elements of an associated membrane group of the plurality of membrane groups and/or between the third membrane elements and the fourth membrane elements, of the associated membrane group; and
each second flow channel of the plurality of second flow channels is formed between the second membrane elements and the third membrane elements of an associated membrane group of the plurality of membrane groups and/or the fourth membrane elements of the associated membrane group and the first membrane elements of an adjacent membrane group of the plurality of membrane groups.

5. The membrane block according to claim 1, wherein all of the plurality of membrane elements are formed identically in relation to each other.

6. The membrane block according to claim 1, wherein a height of the frame defined in the height direction is greater than a thickness of the flat membrane defined in the height direction such that the respective flow channel is formed between the flat membranes of two membrane elements of the plurality of membrane elements that are adjacent in the height direction.

7. The membrane block according to claim 1, wherein a geometric surface of each of the plurality of membrane elements defined transversely to the height direction is smaller than a geometric surface of the membrane block defined transversely to the height direction.

8. The membrane block according to claim 1, wherein:
the plurality of membrane elements each further include at least one corner element extending the frame, the at least one corner element extending outward at a corner of the frame from the frame transverse to the height direction; and
the at least one corner elements and/or the frame of the plurality of membrane elements are stacked on top of each other in the height direction and form a continuous edge region of the membrane block in the height direction.

9. The membrane block according to claim 1, wherein the frame includes at least one stiffening rib connecting two opposing frame regions of the plurality of first frame regions and/or the plurality of second frame regions of the frame stiffening the flat membrane of the respective membrane element.

10. The membrane block according to claim 9, wherein the at least one stiffening rib faces a first flow channel of the plurality of first flow channels and is oriented in the width direction.

11. The membrane block according to claim 1, wherein the second frame regions of the frames of the respective pair of adjacent membrane elements are displaced in relation to one another such that the respective flow channel of the respective pair of adjacent membrane elements is flowable through.

12. The membrane block according to claim 1, wherein the second frame regions of the frames of the respective pair of adjacent membrane elements are displaced in relation to each other such that the respective flow channel of the respective pair of adjacent membrane elements is open to the outside.

13. The membrane block according to claim 1, wherein the second frame regions of the frames of the respective pair of adjacent membrane elements have a distance to one another such that a flowable section is formed between the second frame regions.

14. The membrane block according to claim 13, wherein the respective flow channel of the respective pair of adjacent membrane elements is formed at least in regions via the flowable section.

15. A humidifier, comprising:
a housing; and
a membrane block according to claim 1; and
wherein the membrane block is arranged in the housing.

16. The membrane block according to claim 2, wherein:
the first distance and the third distance are identical to one another; and
the second distance and the fourth distance are identical to one another.

17. The membrane block according to claim 2, wherein:
the first distance and the second distance are identical to one another; and
the third distance and the fourth distance are identical to one another.

18. The membrane block according to claim 2, wherein the first distance, the second distance, the third distance, and the fourth distance is greater than a width of the frame of each of the plurality of membrane elements such that an outwardly extending channel is formed between the frames of each respective pair of adjacent membrane elements.

19. The membrane block according to claim 9, wherein the at least one stiffening rib faces a second flow channel of the plurality of second flow channels and is oriented in the longitudinal direction.

20. A membrane block for a humidifier, comprising:
a plurality of membrane elements stacked one above another in a height direction and oriented transversely to the height direction;
each membrane element of the plurality of membrane elements including a membrane and a rectangular frame enclosing the membrane, the frame extending along an outer perimeter of the membrane;
the frame including i) a plurality of first regions disposed opposite one another and ii) a plurality of second regions disposed opposite one another, the plurality of first regions oriented in a first direction extending transversely to the height direction, the plurality of second regions oriented in a second direction extending transversely to the height direction and to the first direction;
a plurality of flow channels each defined by and between a respective pair of adjacent membrane elements of the plurality of membrane elements, the plurality of flow channels including a plurality of first flow channels and a plurality of second flow channels arranged in an alternating manner in the height direction;
wherein the plurality of first flow channels are closed in the first direction and conduct a through flow in the second direction;
wherein the plurality of second flow channels are closed in the second direction and conduct a through flow in the first direction; and
wherein each pair of adjacent membrane elements includes a first membrane element and a second membrane element that are displaced relative to one another in the first direction and/or in the second direction such that i) the plurality of first frame regions of the frame of the first membrane element abut the plurality of first frame regions of the frame of the second membrane element and ii) the plurality of second frame regions of the frame of the first membrane element do not abut the plurality of second frame regions of the frame of the second membrane element to form a respective flow channel of the plurality of flow channels between the first membrane element and the second membrane element.
